(19) United States
(12) Patent Application Publication
(10) Pub. No.: US 2012/0241552 A1
(43) Pub. Date: Sep. 27, 2012

(54) Damage Resistant Aircraft

(76) Inventor: Francis Xavier Gentile, Los Angeles, CA (US)

(21) Appl. No.: 13/430,592

(22) Filed: Mar. 26, 2012

Related U.S. Application Data
(60) Provisional application No. 61/467,963, filed on Mar. 25, 2011.

(51) Int. Cl. B64C 39/00

(52) U.S. Cl. 244/12.2

(57) ABSTRACT

An aircraft which an inflatable, indestructible self righting “Beach Ball” with almost helicopter performance. A means to make a ball that can roll. also a flying machine that can take off and land vertically. A means of making a helicopter less dangerous. A means of making a helicopter damage resistant. A method to fold up an aircraft like an umbrella.

### CROSS REFERENCE TO RELATED APPLICATIONS

This Application claims the benefit of PPA Ser. No. 61/467,963 filed 2011-Mar.-25 by the present Inventor, which is incorporated by reference.

U.S. Pat. No. 8,016,225 Sep. 13, 2011 by the present Inventor, is related to this application and is incorporated by reference.

### DESCRIPTION

### BRIEF DESCRIPTION OF THE SEVERAL VIEWS OF THE DRAWINGS

### Drawings—Figures

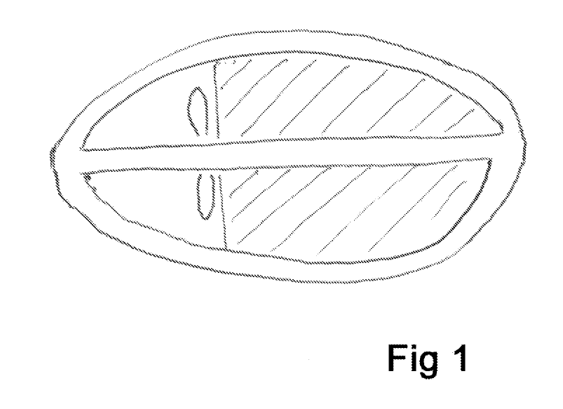

FIG. 1 Football Frame 1 from the side without an exterior net shown.

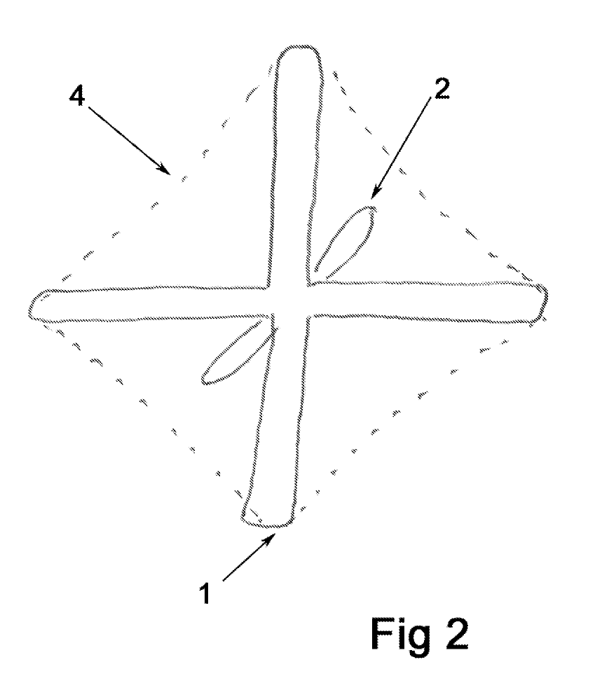

FIG. 2 Front view with tension net 4.

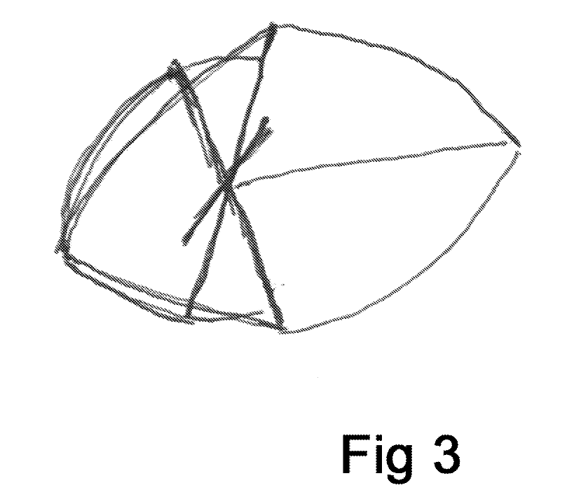

FIG. 3 Stick Frame 1 Style ¾ view.

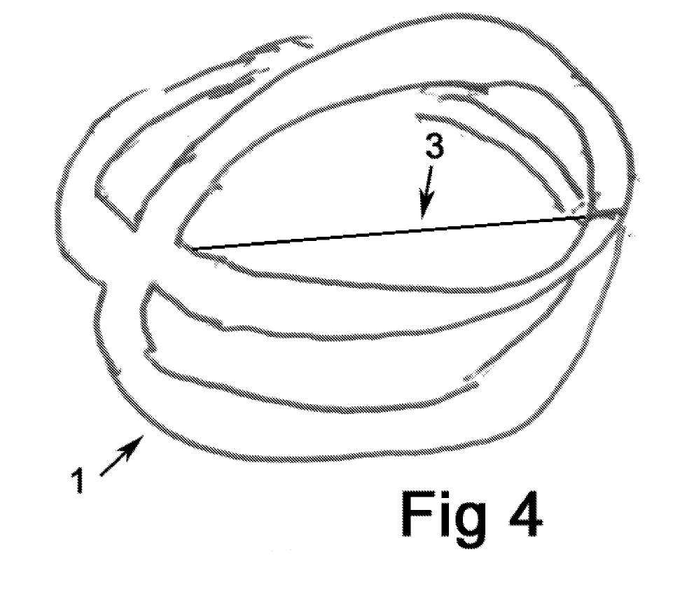

FIG. 4 Football frame with axis cord 3 ¾ view.

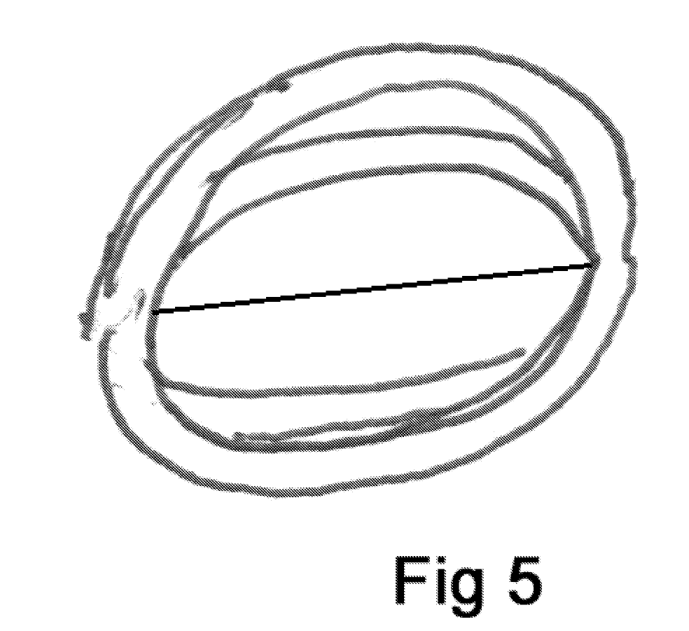

FIG. 5 Beach ball frame and axis cord 3 ¾ view.

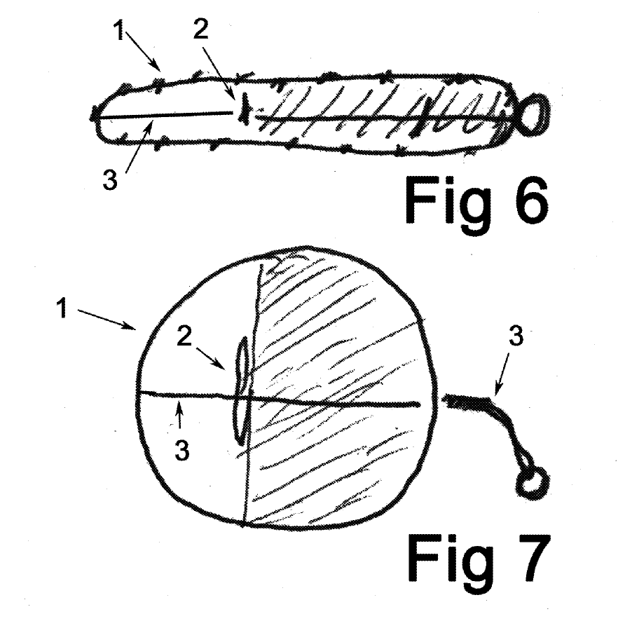

FIG. 6 Beach ball frame folded with axis cord 3 not in tension, side view.

FIG. 7 Beach ball frame in operation position with axis cord 3 in tension, side view.

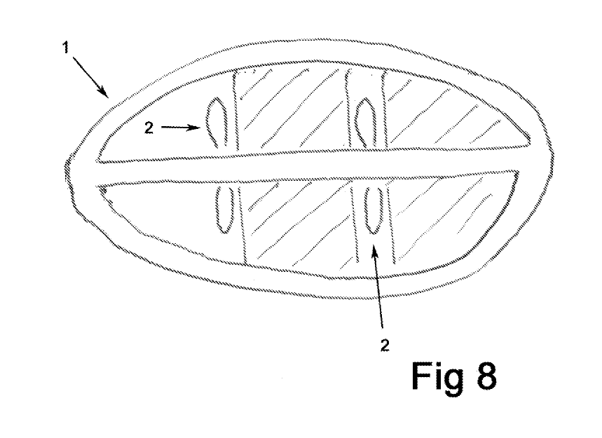

FIG. 8 Football Frame 1 from the side without an exterior net shown, including 2 propellers spaced around a middle center of gravity to facilitate sideways rolling and control on the ground.

An aircraft which an inflatable, indestructible self righting “Beach Ball” with almost helicopter performance. A means to make a ball that can roll. also a flying machine that can take off and land vertically.

A means of making a helicopter less dangerous. A means of making a helicopter damage resistant. A method to fold up an aircraft like an umbrella.

An aircraft that can roll and bounce on the ground, as the compressive loaded structure of the aircraft is also the aircrafts perimeter frame or cage.

Therefore realizing at least a dual use of structure as protection and as air frame. The airframe may be inflatable or of springy sticks similar to a fishing rod. The external ring airframe may be stabilized by a tension netting.

Another embodiment is not a circle but it the shape of a watermelon or an American football and is therefore an aircraft that is easy to throw, and easier to roll sideways on the ground in a controllable direction.

Coaxial Propellers will help to be able to use the props while stationary and for vertical maneuvering. Coaxial propellers spaced for and aft of the center of gravity in flight will help to roll the aircraft sideways on the ground as momentum wheels, air paddle wheels or gyroscopes. Placing the center of gravity near the middle or 50 percent point of the airframe would improve the ability of the aircraft to roll controllably sideways. Placing the wing surface areas aft of the a middle center of gravity will improve the controllability of the sideways rolling of the airframe on the ground FIG. 8.

A single propeller 2 is shown for schematic purposes.

An embodiment of the aircraft exists where the axis cord is a tension member or axis cord FIGS. 4 and 5.

An embodiment of the aircraft where the axis cord is a detachable tension string and therefore the aircraft can fold up to an extremely small percentage of its original size as all internal structure is stabilized by tension.

Propellers concentric with the axis cord would have a hollow driving shaft with the axis cord passing through the propeller.

A tailsitter skid can be attached, a hook can be attached on the nose for hanging from a wire.

What is claimed is:

1. An aircraft with a powered propellers located inside of a structure of more than one ring or arch edgewise to the airflow of normal flight, said propellers attached to share a common diameter axis perpendicular to the airflow of normal flight, wherein;
a) over the aft 75 to 50 percent a tensioned sheet materiel is stretched across the inside of each ring or arch to form a wing or rudder surface;

2. The aircraft of claim 1 comprising;
a) a straight stick or rod materiel that can be bent into an arc and seeks to spring back into its original straight condition;
b) comprising a tension member along the axis line of the common diameter of the rings or arches;
c) Propellers concentric with the axis cord would have a hollow driving shaft with the axis cord passing through the propeller.

3. The aircraft of claim 1 comprising inflatable rings or arches.

4. The aircraft of claim 1, 2 or 3 comprising a tensioned exterior netting attached to the exterior of the each ring or arch to create compressive stress loading in the circular ring frame.

5. The aircraft of claim 1 comprising;
a) a tensioned exterior netting attached to the exterior of the each ring or arch to create compressive stress loading in the circular ring frame;
b) a straight stick or rod materiel that can be bent into an arc and seeks to spring back into its original straight condition;
c) comprising a tension member along the axis line of the common diameter of the rings or arches.
d) where the tension member is a flexible cord capable of disconnection to allow folding of the structure.

6. The aircraft of claim 1, 2, 3, 4, or 5 where the aircraft has a substantially circular shape.

7. The aircraft of claim 1, 2, 3, 4, or 5 where the aircraft has a substantially football or watermelon shape with the pointed ends flying in the direction of the airflow.

8. The aircraft of claim 1, 2, 3, 4, 5, 6 or 7 propellers spaced around a middle center of gravity to facilitate sideways rolling and control on the ground.
